(19) United States
(12) Patent Application Publication
(10) Pub. No.: US 2018/0103111 A1
(43) Pub. Date: Apr. 12, 2018

(54) DETERMINATION OF WELL-KNIT GROUPS IN ORGANIZATIONAL SETTINGS

(71) Applicant: International Business Machines Corporation, Armonk, NY (US)

(72) Inventors: Krishnasuri Narayanam, Bangalore (IN); Ramasuri Narayanam, Andhra Pradesh (IN); Mukundan Sundararajan, Bangalore (IN)

(21) Appl. No.: 15/288,286

(22) Filed: Oct. 7, 2016

(51) Int. Cl. H04L 29/08; H04L 12/58

(52) U.S. Cl. CPC H04L 67/22; H04L 51/32; H04L 67/306; H04L 67/24; H04L 51/04

(57) ABSTRACT

A method for identifying a subgroup of individuals within an organization capable of collaborating, including the steps of: (i) obtaining information about one or more interactions between a plurality of individuals, the information including positive interactions and negative interactions; (ii) generating, based on the obtained information, a signed network comprising a plurality of nodes each representing one of the plurality of individuals, and further comprising a plurality of edges between at least some of the plurality of nodes, wherein an edge is signed positive or negative; (iii) identifying, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and (iv) communicating the identified subgroup of individuals to a user.

### BACKGROUND

The present invention is directed to methods and systems for determining a cooperative collaboration group based on positive and/or negative connections of individuals within a social group.

Organizations consist of numerous individuals that interact with each other in various different ways, both directly and indirectly. These individuals interact in person and via many possible different media, including via the telephone, email, messaging, texting, document management systems, an Intranet, the Internet, and various other media. Indeed, some interactions will be completely virtual interactions, such as interactions between individuals located in different divisions or locations within the organization. These interactions are intended to generate value for the organization by facilitating the creation of a particular good and/or service.

However, in practice, some of the numerous individuals within an organization are able to interact and collaborate easily when executing various tasks, while others within the organization are unable or unwilling to interact or collaborate when executing tasks. The inability to interact or collaborate can be due to many different factors, including but not limited to lack of communication, competing interests, personality differences, and many other factors. The inability to interact or collaborate results in inefficiencies, increased costs, delays, and many other unwanted or undesirable consequences.

As a result, identifying and creating a group of individuals within an organization that is capable of interacting and collaborating without a conflict or other issue is costly, time-consuming, error-prone, and otherwise inefficient.

Accordingly, there is a continued need in the art for systems and methods that facilitate the creation of a group of individuals within an organization capable of interacting and collaborating without conflict.

### SUMMARY

The disclosure is directed to inventive methods and systems for determining a cooperative collaboration group based on positive and/or negative connections of individuals within a social group. Under the present invention, a system is enabled to utilize historical interaction data to calculate a coefficient of collaboration for a set of individuals in a social network based on, for example, the difference between the sum of positive and negative edges among the individuals. The system then utilizes the calculated coefficients of collaboration of individuals within the set to form a subset of individuals that are capable of interacting and collaborating without conflict. In one embodiment, the system utilizes a learning network that uses a level of success of endeavors in the social network to identify the subset.

According to an aspect is a method for identifying a subgroup of individuals among a plurality of individuals. The method includes the steps of: (i) obtaining information about one or more interactions between a plurality of individuals, wherein the information comprises positive interactions and negative interactions; (ii) generating, based on the obtained information, a signed network comprising a plurality of nodes each representing one of the plurality of individuals, and further comprising a plurality of edges between at least some of the plurality of nodes, wherein each of the plurality of edges represents an interaction, and further wherein an edge is signed positive if the interaction between the two respective nodes joined by the edge is positive, and wherein an edge is signed negative if the interaction between the two respective nodes joined by the edge is negative; (iii) identifying, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and (iv) communicating the identified subgroup of individuals to a user.

According to an embodiment, each of the plurality of individuals is a member of an organization.

According to an embodiment, the method includes the step of storing the obtained information about one or more interactions between the plurality of individuals.

According to an embodiment, the size of the collaboration team is predetermined by the user. According to an embodiment, the size of the collaboration team is based on a predetermined range.

According to an embodiment, the method further includes the steps of receiving feedback regarding the identified subgroup of individuals; and modifying a subsequent identified subgroup of individuals based in part on the received feedback.

According to an embodiment, the coefficient of collaboration further comprises a weighting factor for the positive edges and a weighting factor for the negative edges. According to an embodiment, the coefficient of collaboration (σ(I)) is calculated using the following formula: σ(I)=Weight(T⁺(I))−Weight(T⁻(I)), where Weight(T⁺(I) is the weighted set of positive edges, and Weight(T⁻(I) is the weighted set of negative edges.

According to an aspect is a computer system configured to identify a subgroup of individuals among a plurality of individuals. The system comprises: a processor configured to: (i) obtain information about one or more interactions between a plurality of individuals, wherein the information comprises positive interactions and negative interactions; (ii) generate, based on the obtained information, a signed network comprising a plurality of nodes each representing one of the plurality of individuals, and further comprising a plurality of edges between at least some of the plurality of nodes, wherein each of the plurality of edges represents an interaction, and further wherein an edge is signed positive if the interaction between the two respective nodes joined by the edge is positive, and wherein an edge is signed negative if the interaction between the two respective nodes joined by the edge is negative; (iii) identify, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and a user interface configured to communicate the identified subgroup of individuals to a user.

According to an embodiment, the system further includes a social network comprising the information about the one or more interactions between the plurality of individuals.

According to an aspect is a computer program product for identifying a subgroup of individuals among a plurality of individuals. The computer program product includes a computer readable storage medium having program instructions embodied therewith, wherein the computer readable storage medium is not a transitory signal per se. The program instructions readable by a computer to cause the computer to perform a method comprising: (i) obtaining information about one or more interactions between a plurality of individuals, wherein the information comprises positive interactions and negative interactions; (ii) generating, based on the obtained information, a signed network comprising a plurality of nodes each representing one of the plurality of individuals, and further comprising a plurality of edges between at least some of the plurality of nodes, wherein each of the plurality of edges represents an interaction, and further wherein an edge is signed positive if the interaction between the two respective nodes joined by the edge is positive, and wherein an edge is signed negative if the interaction between the two respective nodes joined by the edge is negative; (iii) identifying, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and (iv) communicating the identified subgroup of individuals to a user.

These and other aspects of the invention will be apparent from the embodiments described below.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a system for identifying a subgroup of individuals within an organization capable of interacting and collaborating without conflict, in accordance with an embodiment.

FIG. 2 is a flow chart of a method for identifying a subgroup of individuals within an organization capable of interacting and collaborating without conflict, in accordance with an embodiment.

FIG. 3 is a schematic representation of a signed social graph depicting interactions between nodes, in accordance with an embodiment.

FIG. 4 is a schematic representation of a signed social graph depicting interactions between nodes, in accordance with an embodiment.

FIG. 5 is a schematic representation of a system for identifying a subgroup of individuals within an organization, in accordance with an embodiment.

### DETAILED DESCRIPTION

The present disclosure is directed to embodiments of a method and system for creating a sub-group or sub-set of individuals within an organization capable of interacting and collaborating without conflict, based on evaluation of historical interactions between the individuals. According to an embodiment, the method and system calculates a coefficient of collaboration for a set of individuals in a social network based on the difference between the sum of positive and negative edges among the individuals. The method and system then forms a subset of individuals that are capable of interacting and collaborating without conflict, based on the calculated coefficients of collaboration of individuals within the set.

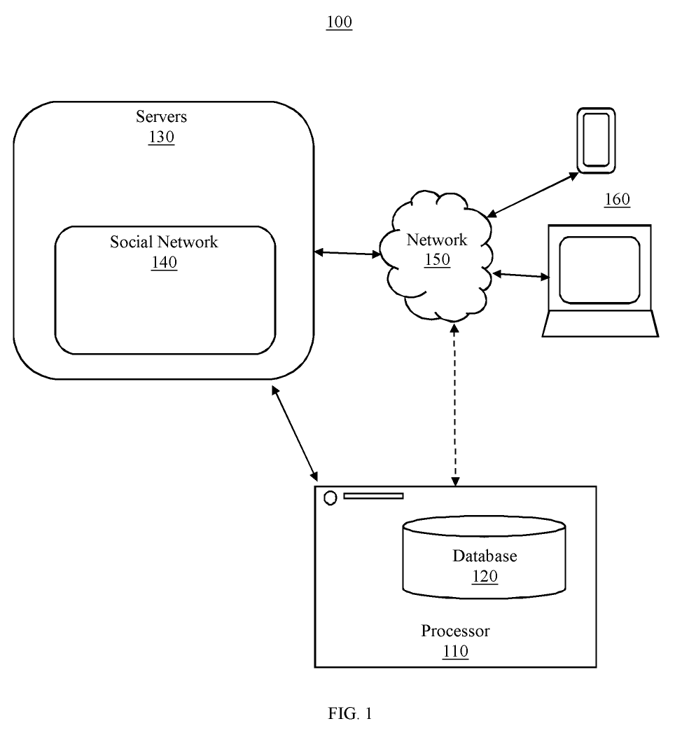

Referring to FIG. 1, in one embodiment, is a system 100 for identifying a subgroup of individuals within an organization capable of interacting and collaborating without conflict. According to an embodiment, system 100 comprises a data processing environment comprising a processor 110 configured to identify a subgroup of individuals within an organization capable of interacting and collaborating without conflict. The processor 110 comprises or is in communication with a database 120 which is configured to store information utilized by the processor and/or output from the processor 110. According to an embodiment, data processing environment including processor 110 may be in communication with one or more servers 130 comprising a social network 140. The processor 110 can be a component of the social network 140, or can be remote from the social network. The processor may comprise, for example, an algorithm configured to comprise, perform, or otherwise execute any of the functionality described or otherwise envisioned herein. According to an embodiment, the processor 110 receives information from or otherwise accesses the social media content directly or through network 150. The wired or wireless communication network 140 can be, for example, the Internet, a LAN, Internet, cellular network, or any of a variety of other networks. The processor and algorithm can then process the accessed data according to the methods described or otherwise envisioned herein.

According to an embodiment, social network 140 can be any of the existing social networks, or can be any new social network. Typically, a social network comprises a plurality of users who have relationship networks. The social network may comprise a system in which users extend and accept relationship requests, or may comprise a system in which relationships are automatically created between users, or may comprise a mixed system where relationships are both manually and automatically created. Typically, a social network user will utilize a computer 160 to log into the social network site via a user interface to view the relationships, to post their own content, to view the content posted by other users including users in their network, and/or to comment on or otherwise provide feedback to the content of others. Alternatively or additionally, users can access the social network through an app on their laptop, desktop, smartphone, PDA, wearable computer technology, or through any connection 160 capable of or configured for access to the social network.

According to an embodiment, the social network 140 is an organizational network, such as an Intranet, internal messaging system, email system, or other form of interaction between employees or members of an organization. Such a social network may be organized and/or stored or located within the organization or outside the organization.

According to an embodiment, the social network users utilize a computer 160 to access the servers 130 and social network 140, and thus a wired or wireless communication network 150 can exist between the user's computer 160 and the social network and servers. The wired or wireless communication network 150 can be, for example, the Internet, a LAN, Internet, cellular network, or any of a variety of other networks.

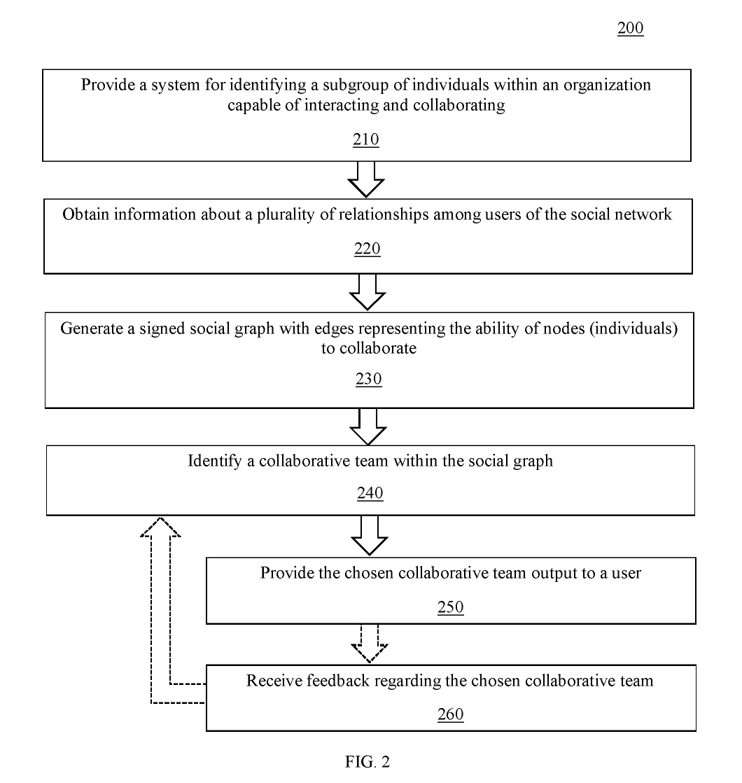

Referring to FIG. 2, in one embodiment, is a flowchart of a method 200 for identifying a subgroup of individuals within an organization capable of interacting and collaborating. According to an embodiment, at step 210 of the method, a system 100 is provided. System 100 can comprise any of the components described or otherwise envisioned herein, including but not limited to the data processing environment comprising a processor 110 configured to identify a subgroup of individuals within an organization capable of interacting and collaborating without conflict, and the database 120 which is configured to store information utilized by the processor and/or output from the processor 110. The system 100 may also comprise—or have access to—a social network 140. Alternatively, the system may comprise only the processor 110 configured with an algorithm to identify a subgroup of individuals within an organization capable of collaborating based on historical interaction data obtained directly and/or indirectly from one or more social networks 140, and/or other sources.

According to an embodiment, the method forms a team of cooperative and collaborative people who have a documented history of being able to work cooperatively and collaborative with one another. Accordingly, the method is able to form this team or group with short notice and without significant resources. According to one embodiment, the system forms a team or subgroup that has as many positive edges and as much positive weight between nodes or members of the group as possible, while simultaneously having as few negative edges and as little negative weight between those nodes as possible. Normally, forming a collaborative group with minimal negative interactions or edges and maximum positive interactions or edges can be time-consuming and demand numerous resources, due to at least the availability of an exponential number of candidate teams and many degrees of collaboration among the team members.

At step 220 of the method, the system obtains information about a plurality of interactions—also referred to as relationships or edges—between a plurality of users of a social network, where the users are employees, members, or otherwise affiliated with the organization within which a subgroup is being formed. For example, the system can be continuously connected to the social network, or can periodically query or receive data from the social network. Additionally, the social network may be one social network or multiple social networks. These social networks can be any of the networks described or otherwise envisioned herein. The information received from the social network can be utilized or processed or analyzed immediately, and/or can be stored for analysis at a later time or date.

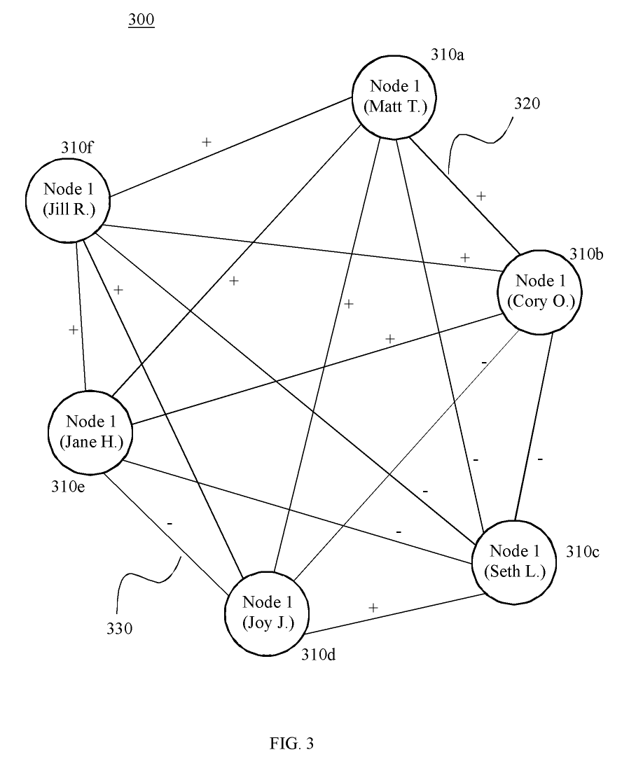

At step 230 of the method, the system generates a signed social graph using the received information about interactions among users of the social network. The signed social graph is generated, for example, from historical data obtained from the social network. Referring to FIG. 3, for example, is a signed social graph 300 according to one possible embodiment. The individuals are modeled as nodes 310 (such as 310a-310f) within the graph. The nodes are connected by edges 320, 330 that represent a quantification of the interaction between those nodes. For example, edge 320 is a positive edge which represents that the corresponding two individuals have and/or can collaborate easily, while edge 330 is a negative edge which represents that the corresponding two individuals have not and/or cannot collaborate. According to one embodiment, the degree of collaboration is represented by a value between −1 and +1.

According to an embodiment, in order to form a team of size k with a social graph of G=(V,E) and an integer k<|V|, the issue of generating a team of size k is to determine a set I⊂V of size k such that the value of the coefficient of collaboration σ(I) is maximized.

The social graph may be created and maintained using any of a variety of mechanisms. According to one embodiment, the network can be modeled as a graph G=(V,S,W) where V is the set of individuals (or autonomous entities) within the organization. In other words, V is the possible universe of individuals that can make up the collaboration teams. S is the sign function representing positive or negative links or edges, and W is a weight function.

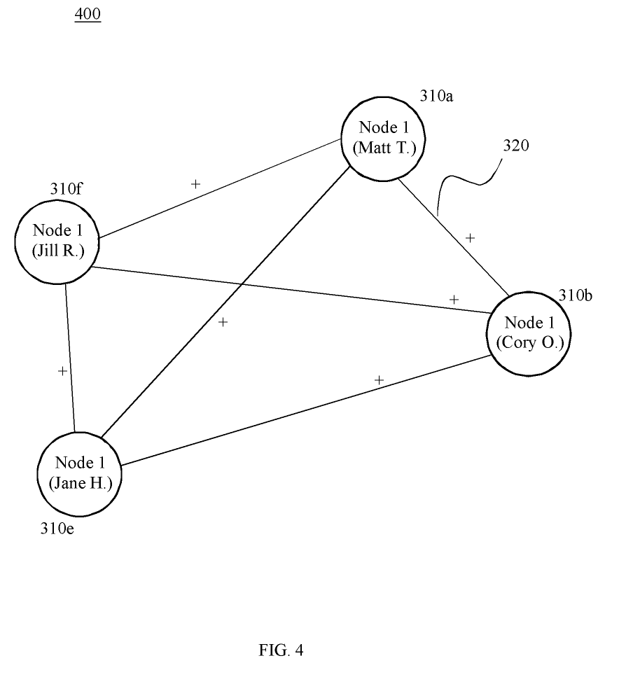

At step 240 of the method, the system generates or identifies a team or subgroup within the social graph that is most able to collaborate and cooperate effectively and efficiently. Referring to FIG. 4, for example, the system has identified a subgroup of four individuals within the 6-member organization. This team maximizes positive edges while minimizing negative edges, thereby provide a highly collaborative and cooperative group.

According to an embodiment, to calculate a coefficient of collaboration of a set, the system uses the following definitions. First, I⊂V is a subset of vertices in the graph G. Further, T⁺(I)⊂ V is the set of positive links among the nodes in I. In other words:

T⁺(I)={w(j,i)|s(j,i)=+1, jεI, iεI} (Eq. 1)

Similarly, T⁻(I)⊂ V is the set of negative links among the nodes in I. In other words:

T⁺(I)={w(j,i)|s(j,i)=−1, jεI, iεI} (Eq. 2)

To determine the coefficient of collaboration, I c V is considered. The coefficient of collaboration can be σ(I), which is the difference between the weights of elements in T⁺(I) and T⁻(I), such as the following equation:

σ(I)=Weight(T⁺(I))−Weight(T⁻(I)) (Eq. 3)

According to an embodiment, yet another algorithm for identifying a collaborative team of size k is based on the Hill-Climbing technique. However, unlike the Hill-Climbing technique, this system models the coefficient of collaboration as the objective function, and maximizes the coefficient of collaboration in order to determine the collaborative team. According to an embodiment, this algorithm approximates the collaborative team of size k problem within a ration of (1−e^{-Hk}), where Hₖ is the k^{th} harmonic number. According to the algorithm:

Set I₀ ← φ
for i = l to k do

Choose a node nᵢ ∈ N\Iᵢ₋ₗ that maximizes σ(Iᵢ₋ₗ ∪ {nᵢ} − σ(Iᵢ₋ₗ)
Set Iᵢ ← Iᵢ₋ₗ ∪ {nᵢ}

end for

According to an embodiment, there are several possible heuristics for selecting a collaborative group of size k. According to the first heuristic, the so-called “in-degree heuristic,” for each node the net-in-degree is defined as the difference between the number of positive in-coming links and the number of negative in-coming links, and the top-k nodes with high net-in-degree are chosen. According to the second heuristic, the so-called “out-degree heuristic,” for each node the net-out-degree is defined as the difference between the number of positive out-coming links and the number of negative out-coming links, and the top-k nodes with high net-out-degree are chosen.

At step 250 of the method, the collaborative team of size k has been chosen or selected by the system using any of the embodiments described or otherwise envisioned herein, and the output is provided to a user. For example, the output can be provided to the user through a user interface, an email, text message, list, printout, alert, or any other notification mechanism. The output can be a simple list of individuals, or can be a graph of the individuals and including other information such as information about their interactions. For example, the output can include information about the social graph constructed in a prior step of the method. As one example, the output can include the edges between the members of the collaborative group, such as the output shown in FIG. 4, among many other options.

At optional step 260, the system can use one or more measures of success of the selected collaboration team to evaluate the selection process. For example, the system may comprise a learning module or system, such as a neural network, that uses one or more measurements or data sources to evaluate the efficiency, collaborative nature, or other facet or feature of the selected collaboration team in order to improve the method of selection. This information can be utilized the next time a collaboration team is selected. For example, the learning module or system can receive information about the interactions of the members of the selected collaboration team as the team works together on a project. The learning module or system may receive information, for example, that suggests that the collaboration team cannot function together efficiently. The learning module or system may then use that information about the selected team and the feedback in order to make changes to the selection process. This adaptation can be iterative and can involve, for example, a neural network or other learning network.

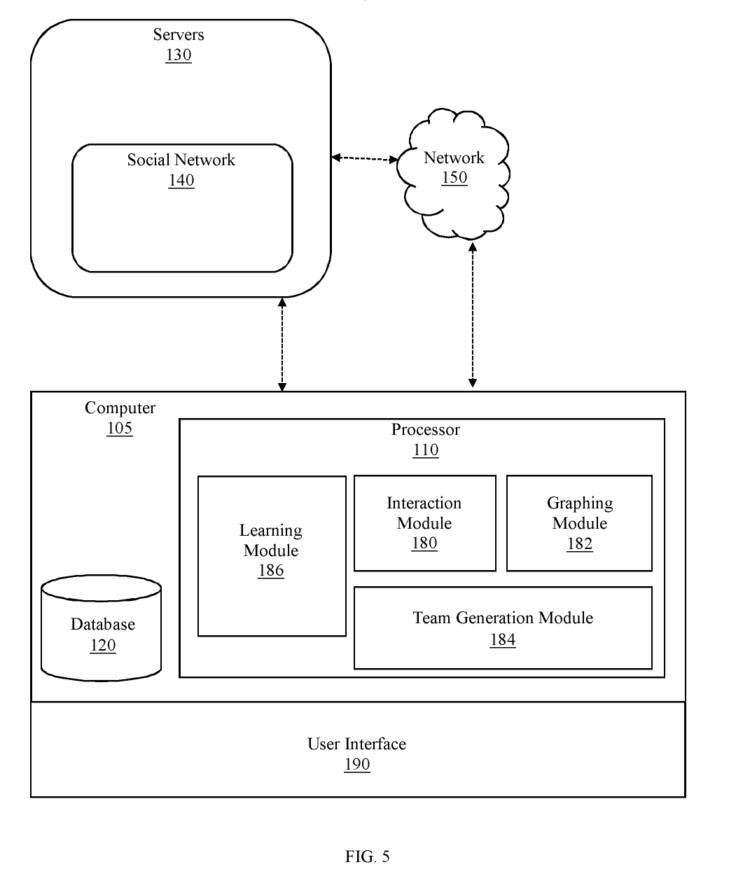

Referring to FIG. 5, in one embodiment, is a system 500 for identifying a subgroup of individuals within an organization capable of interacting and collaborating. According to an embodiment, system 500 can comprise any of the components described or otherwise envisioned herein, including but not limited to the data processing environment in the form of a computer or server 105, which can comprise a processor 110 configured to identify a subgroup of individuals within an organization capable of interacting and collaborating without conflict, and the database 120 which is configured to store information utilized by the processor and/or output from the processor 110. The system 500 may also comprise—or have access to—a social network 140. Alternatively, the system may comprise only the processor 110 configured with an algorithm to identify a subgroup of individuals within an organization capable of collaborating based on historical interaction data obtained directly and/or indirectly from one or more social networks 140, and/or other sources.

According to an embodiment, computer or server 105 can comprise, in the form of a module and/or in the form of programming of processor 110, an interaction module 180. Interaction module 180 is configured to obtain information about a plurality of interactions—also referred to as relationships or edges—between a plurality of individuals, where the individuals are employees, members, or otherwise affiliated with the organization within which a subgroup is being formed. For example, the system can be continuously connected to a source of data about these interactions, or can periodically query or receive data from the data source or sources. Indeed, the data source may be one data source or multiple data sources. The information received from the data source can be utilized or processed or analyzed immediately, and/or can be stored for analysis at a later time or date. Accordingly, computer or server 105 can comprise a database 120 configured to store the information received from the data source, and/or any of the other information or items described or otherwise envisioned herein.

Computer or server 105 can comprise, in the form of a module and/or in the form of programming of processor 110, a graphing module 182 configured to generate a signed social graph using the received information about interactions among users of the social network. The signed social graph is generated, for example, in real-time and/or from historical data obtained from the one or more data sources, such as social network 140. Referring to FIG. 3, for example, is a signed social graph 300 according to one possible embodiment.

Computer or server 105 can comprise, in the form of a module and/or in the form of programming of processor 110, a team generation module 182 which is configured to generate or identify a team or subgroup within the social graph that is most able to collaborate and cooperate effectively and efficiently. Referring to FIG. 4, for example, the system has identified a subgroup of four individuals within the 6-member organization. This team maximizes positive edges while minimizing negative edges, thereby provide a highly collaborative and cooperative group.

Computer or server 105 can comprise, in the form of a module and/or in the form of programming of processor 110, a learning module or system 186 which is configured to evaluate the efficiency, collaborative nature, or other facet or feature of the selected collaboration team in order to improve the method of selection. For example, learning module or system 186 may be a neural network or any other type of learning algorithm, module, or device. The information obtained by the module can be utilized the next time a collaboration team is selected. For example, the learning module or system can receive information about the interactions of the members of the selected collaboration team as the team works together on a project. The learning module or system may receive information, for example, that suggests that the collaboration team cannot function together efficiently. The learning module or system may then use that information about the selected team and the feedback in order to make changes to the selection process. This adaptation can be iterative and can involve, for example, a neural network or other learning network.

Notably, interaction module 180, graphing module 182, team generation module 182, and/or learning module or system 186 can be individual modules, a single module, or can be any combination of one or more modules.

According to an embodiment, computer or server 105 can comprise a user interface 190 configured or programmed to communicate information to a user. Accordingly, user interface 190 can be any user interface capable of communicating information, either visually, by touch, by sound, by printout, or by any other method or means of communication. For example, user interface 190 may be a monitor or display that provides a list or other graphical representation of the information from team generation module 182. According to one example, the user interface 190 provides a graphical representation similar to the graph shown in FIG. 4, which includes information about the relationships between the selected individuals. As another example, the user interface can provide a list of the names of the individuals selected. Many other methods of displaying the information are possible.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising the steps of:
obtaining information about one or more interactions between a plurality of individuals, wherein the information comprises positive interactions and negative interactions;
generating, based on the obtained information, a signed network comprising a plurality of nodes each representing one of the plurality of individuals, and further comprising a plurality of edges between at least some of the plurality of nodes, wherein each of the plurality of edges represents an interaction, and further wherein an edge is signed positive if the interaction between the two respective nodes joined by the edge is positive, and wherein an edge is signed negative if the interaction between the two respective nodes joined by the edge is negative;
identifying, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and
communicating the identified subgroup of individuals to a user.

2. The method of claim 1, wherein each of the plurality of individuals is a member of an organization.

3. The method of claim 1, further comprising the step of storing the obtained information about one or more interactions between the plurality of individuals.

4. The method of claim 1, wherein the size of the collaboration team is predetermined by the user.

5. The method of claim 1, wherein the size of the collaboration team is based on a predetermined range.

6. The method of claim 1, further comprising the steps of:
receiving feedback regarding the identified subgroup of individuals; and
modifying a subsequent identified subgroup of individuals based in part on the received feedback.

7. The method of claim 1, wherein the coefficient of collaboration further comprises a weighting factor for the positive edges and a weighting factor for the negative edges.

8. The method of claim 1, wherein the coefficient of collaboration (σ(I)) is calculated using the following formula: σ(I)=Weight(T⁺(I))−Weight(T⁻(I)), where Weight(T⁺(I) is the weighted set of positive edges, and Weight(T⁻(I) is the weighted set of negative edges.

9. A computer system configured to identify a subgroup of individuals among a plurality of individuals, the system comprising:
a processor configured to: (i) obtain information about one or more interactions between a plurality of individuals, wherein the information comprises positive interactions and negative interactions; (ii) generate, based on the obtained information, a signed network comprising a plurality of nodes each representing one of the plurality of individuals, and further comprising a plurality of edges between at least some of the plurality of nodes, wherein each of the plurality of edges represents an interaction, and further wherein an edge is signed positive if the interaction between the two respective nodes joined by the edge is positive, and wherein an edge is signed negative if the interaction between the two respective nodes joined by the edge is negative; (iii) identify, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and
a user interface configured to communicate the identified subgroup of individuals to a user.

10. The system of claim 9, further comprising a social network comprising the information about the one or more interactions between the plurality of individuals.

11. The system of claim 9, further comprising a database, wherein the processor is further configured to store the obtained information about one or more interactions between the plurality of individuals.

12. The system of claim 9, wherein the size of the collaboration team is predetermined by the user.

13. The system of claim 9, wherein the processor is further configured to: (i) receive feedback regarding the identified subgroup of individuals; and (ii) modify a subsequent identified subgroup of individuals based in part on the received feedback.

14. The system of claim 9, wherein the coefficient of collaboration further comprises a weighting factor for the positive edges and a weighting factor for the negative edges.

15. The system of claim 14, wherein the coefficient of collaboration (σ(I)) is calculated using the following formula: σ(I)=Weight(T⁺(I))−Weight(T⁻(I)), where Weight(T⁺(I) is the weighted set of positive edges, and Weight(T⁻(I) is the weighted set of negative edges.

16. A computer program product for identifying a subgroup of individuals among a plurality of individuals, the computer program product comprising a computer readable storage medium having program instructions embodied therewith, wherein the computer readable storage medium is not a transitory signal per se, the program instructions readable by a computer to cause the computer to perform a method comprising:
obtaining information about one or more interactions between a plurality of individuals, wherein the information comprises positive interactions and negative interactions;
generating, based on the obtained information, a signed network comprising a plurality of nodes each representing one of the plurality of individuals, and further comprising a plurality of edges between at least some of the plurality of nodes, wherein each of the plurality of edges represents an interaction, and further wherein an edge is signed positive if the interaction between the two respective nodes joined by the edge is positive, and wherein an edge is signed negative if the interaction between the two respective nodes joined by the edge is negative;
identifying, using the signed network, a subgroup of individuals among the plurality of individuals, the subgroup of individuals comprising a maximum coefficient of collaboration, wherein the coefficient of collaboration is the difference between the sum of positive edges and negative edges between the group of individuals; and
communicating the identified subgroup of individuals to a user.

17. The computer program product of claim 16, wherein the method further comprises storing the obtained information about one or more interactions between the plurality of individuals.

18. The computer program product of claim 16, wherein the size of the collaboration team is predetermined by the user.

19. The computer program product of claim 16, wherein the method further comprises: (i) receiving feedback regarding the identified subgroup of individuals; and (ii) modifying a subsequent identified subgroup of individuals based in part on the received feedback.

20. The computer program product of claim 16, wherein the coefficient of collaboration further comprises a weighting factor for the positive edges and a weighting factor for the negative edges.
